(19) United States
(12) Patent Application Publication
(10) Pub. No.: US 2017/0136609 A1
(43) Pub. Date: May 18, 2017

(54) Tractor PTO Driveline Shaft Alignment Tool

(71) Applicant: Edward C. STANLEY, Parker, TX (US)

(72) Inventor: Edward C. STANLEY, Parker, TX (US)

(21) Appl. No.: 14/943,007

(22) Filed: Nov. 16, 2015

(51) Int. Cl. B25B 13/50; B25B 13/08

(52) U.S. Cl. CPC B25B 13/50; B25B 13/08

(57) ABSTRACT

An alignment tool for manually rotating a power take-off driveline shaft having a plurality of splines separated by a plurality of grooves, the tool includes a semi-circular work head having first and second ends, wherein the first end includes a tip portion pointing inwardly toward a center of the semi-circular work head, and a handle having a first end attached to the second end of the semi-circular work head, wherein a longitudinal axis of the handle is disposed at an acute angle from the semi-circular work head. The semi-circular work head is configured to fit around the power take-off driveline shaft with the tip portion engaging one of the plurality of grooves, and a force may be applied to the handle to manually rotate the power take-off driveline shaft.

### FIELD

The present disclosure relates to the field of hand tools and implements, and in particular a tractor power take-off (PTO) driveline shaft alignment tool.

### BACKGROUND

Farm or agricultural tractors are ubiquitous on farms big and small. These tractors are the workhorse of the modern farm, capable of many different functions depending on the implement or accessory attached to the tractor. A conventional tractor is typically attached to an implement or accessory by its power take-off (PTO) driveline shaft projected from the rear end of the transmission case located at the back of the tractor. A PTO is any of several methods for taking power from a power source, such as a running engine, and transmitting it to an attached accessory, implement, or machine. While the engine powers the forward movement of the tractor, it also rotates the PTO driveline shaft to drive any number of accessories, implements, or machines, such as tillers, mowers, sweepers, mixers, cutters, pumps, and many other attachments.

PTOs are standardized in dimensions and speed by the International Standardization Organization (ISO). PTO shafts for agricultural tractors and commercial vehicles may come in a variety of standard sizes and may have, for example, six (6), twenty (20), and twenty-one (21) splines. The six-spline Type 1 PTO shaft has a diameter of 1⅜″ and rotates at 540 RPM, the twenty-one spline Type 2 PTO shaft also has a diameter of 1⅜″ and rotates at 1000 RPM, the twenty-spline Type 3 PTO shaft has a diameter of 1¾″ and rotates at 1000 RPM. To engage and drive the added implement, the splines of the PTO driveline shaft must be in alignment with the inwardly-directed splines inside a hollow input shaft extending from the implement.

### BRIEF DESCRIPTION OF THE DRAWINGS

FIG. 1 is a front perspective view of an exemplary embodiment of a tractor PTO driveline alignment tool according to the teachings of the present disclosure;

FIG. 2 is a front view of an exemplary embodiment of a tractor PTO driveline alignment tool according to the teachings of the present disclosure;

FIG. 3 is a back view of an exemplary embodiment of a tractor PTO driveline alignment tool according to the teachings of the present disclosure;

FIG. 4 is an end view of an exemplary embodiment of a tractor PTO driveline alignment tool according to the teachings of the present disclosure;

FIG. 5 is a bottom view of an exemplary embodiment of a tractor PTO driveline alignment tool according to the teachings of the present disclosure;

FIG. 6 is a front perspective view of an exemplary embodiment of a tractor PTO driveline alignment tool being applied to a PTO driveline shaft according to the teachings of the present disclosure;

FIG. 7 is a front view of an exemplary embodiment of a tractor PTO driveline alignment tool being applied to a PTO driveline shaft according to the teachings of the present disclosure; and

FIG. 8 is an end perspective view of an exemplary embodiment of a tractor PTO driveline alignment tool being applied to a PTO driveline shaft according to the teachings of the present disclosure.

### DETAILED DESCRIPTION

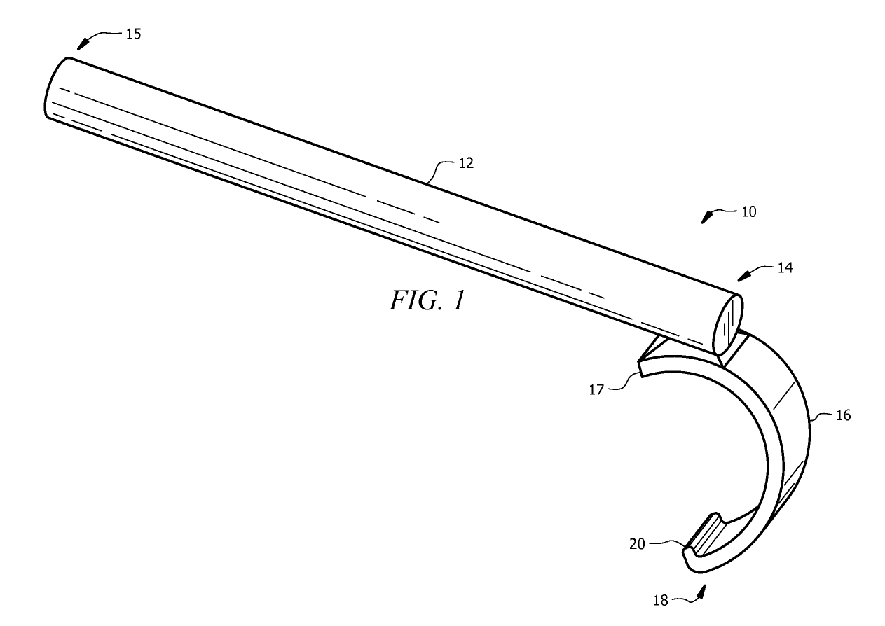

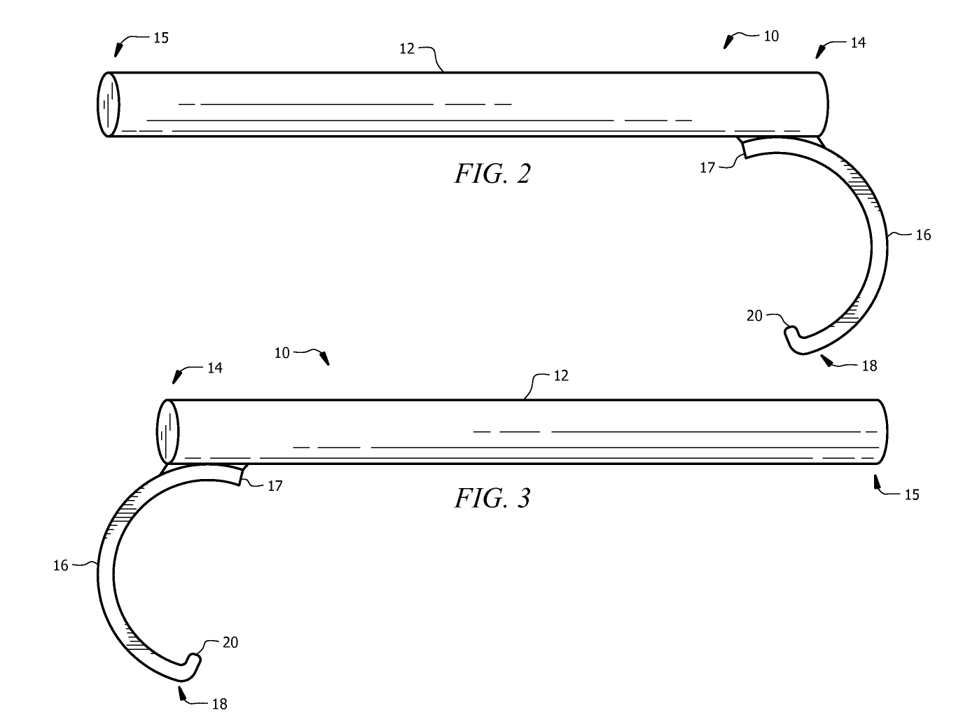

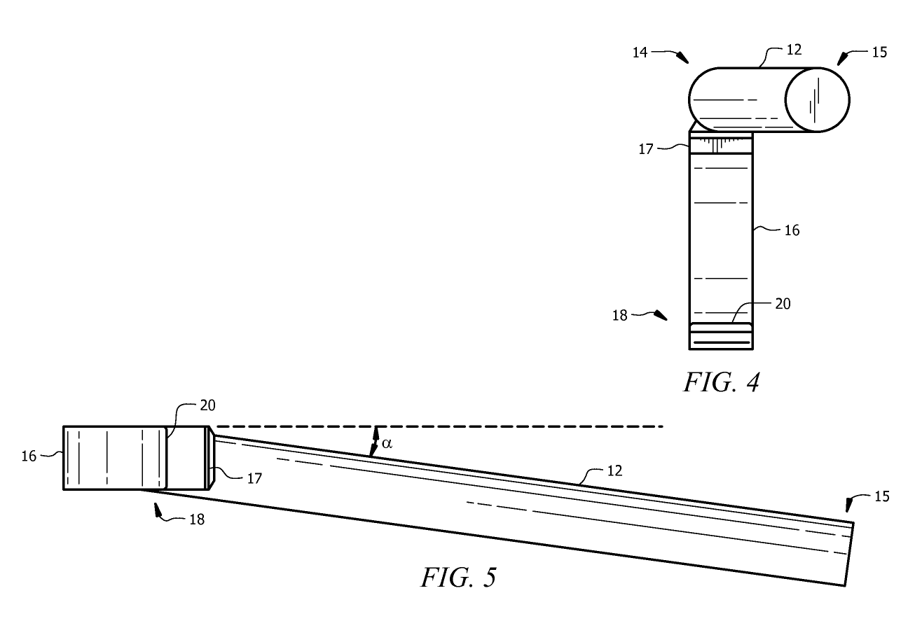

Referring to FIGS. 1-5 for various views of an exemplary embodiment of a tractor PTO driveline alignment tool 10 according to the teachings of the present disclosure, the tool 10 includes two major parts, a handle 12 and a semi-circular work head 16. The handle has two ends 14 and 15 and the semi-circular work head 16 also has two ends 17 and 18. The first end 14 of the handle 12 is coupled to the semi-circular work head 16 near one end 17. It may be best seen in FIGS. 4 and 5 that the handle 12 is securely fastened to the semi-circular work head 16 at an acute angle α. In other words, the longitudinal axis of the handle 12 is at an acute angle α from the semi-circular work head 16. One end 18 of the semi-circular work head 16 includes a bent portion 20 that bends inwardly toward the center of the semi-circular work head 16. The angle of the bend is approximately 90 degrees but may deviate from this angle. The semi-circular work head 16 is the part of the tool 10 that is used to engage and rotate the PTO driveline shaft. The bent end 20 of the semi-circular work head 16 is the part that is used to securely engage a groove situated between the splines of the PTO driveline shaft. The operations of the tool 10 is described in more detail below.

The handle 12 and semi-circular work head 16 of the tractor PTO driveline shaft alignment tool 10 is preferably fabricated from any suitable metal, such as ductile iron, aluminum, steel, and alloy metals. The handle 12 is preferably welded or otherwise securely attached to the semi-circular work head 16.

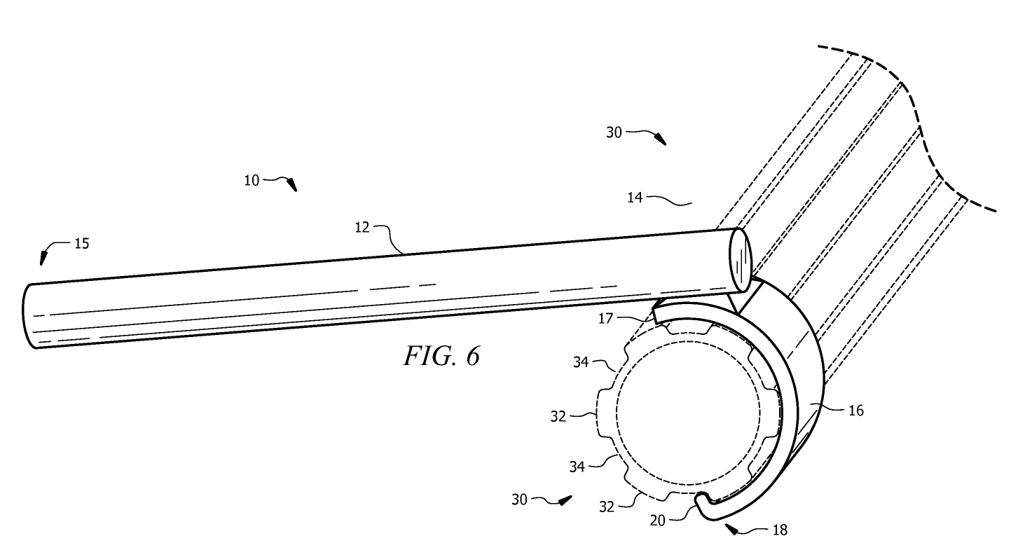

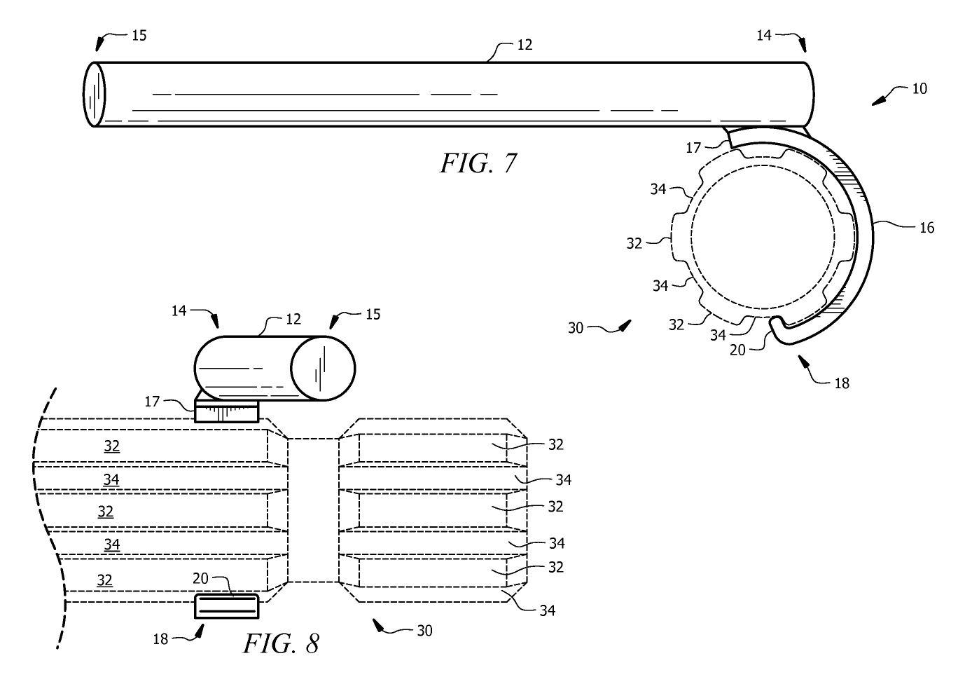

Referring to FIGS. 6-8 for various views of an exemplary embodiment of a tractor PTO driveline alignment tool 10 being applied to a PTO driveline shaft 30 according to the teachings of the present disclosure. The standard PTO driveline shaft 30 has a plurality of equally-spaced splines 32 circumferentially arranged around the shaft and perpendicular to a longitudinal center axis of the shaft 30. The splines 32 are separated by equidistant grooves 34. Shown in FIGS. 6-8 is a standard six-spline PTO driveline shaft 30 that has a diameter of 1⅜″. In this exemplary embodiment, the semi-circular work head 16 of the tool 10 also has an inside diameter of 1⅜″ to correspond with the PTO driveline shaft diameter. In a preferred embodiment, the semi-circular work head 16 may be fabricated from a strip of metal approximately ⅞″ wide. The handle 12 may be constructed from a rod having a length of approximately 5.5″ and a cross-sectional diameter of approximately ½″. It should be noted that the handle 12 may have other shapes, for example, a flat rectangular handle, a rod having an oval cross-section, etc.

When a tractor user wants to drive an accessory or implement using the PTO driveline shaft 30 of the tractor, the angular position of the splines 32 and grooves 34 on the shaft 30 often must be manually adjusted in order to align them with the inwardly-directed splines on the inside of an input shaft extending from the accessory or implement. The PTO driveline shaft 30 can only be inserted into the hollow input shaft of an accessory or implement when the grooves 34 of the PTO driveline shaft 30 are in alignment with the splines of the input shaft. When the grooves and the splines are not in alignment, the PTO driveline shaft 30 must be manually rotated so that alignment is achieved. Using the PTO driveline shaft alignment tool 10 by placing the semi-circular work head 16 over the PTO driveline shaft 30 with the handle 12 extending to the left of the shaft (when viewed from behind the tractor), and the bent tip 20 inserted into a groove 34 of the shaft 30, the tractor user can easily assert sufficient angular force or torque on the handle 12 to rotate the PTO driveline shaft 30 in a counterclockwise direction (when viewed from behind the tractor). It should be noted that the tool 10 can be placed at any point on the PTO driveline shaft 30 as long as the bent tip 20 of the tool can engage one of the grooves 34 on the shaft 30. For example, the tool 10 may be placed under the PTO driveline shaft 30 with the handle 12 extending to the right from the shaft 30 (when viewed from behind the tractor), and using the tool to rotate the shaft in a counterclockwise direction (when viewed from behind the tractor). Once the splines and grooves of the PTO driveline shaft 30 and the accessory input shaft are in alignment, the two can be easily joined together.

As noted above, the handle 12 is secured to the semi-circular work head 16 at an acute angle. The slight angle allows the handle 12 and the user's hand to have sufficient clearance from the body of the tractor when the tool 10 is being used to rotate the PTO driveline shaft 30. The PTO driveline shaft alignment tool 10 may be fabricated with the handle pivoted at an acute angle in either direction to satisfy the left-handed and right-handed preferences of the users. In either direction, the acute angle of the handle 12 with respect to the semi-circular work head 16 creates sufficient clearance for the user's hand so that the tool can be easily used to rotate the PTO driveline shaft 30.

In an alternate embodiment, a separate blunt tip (not explicitly shown) may be welded to the end 18 of the semi-circular work head 16 to form an inwardly pointing tip. The blunt tip may have a square cross-section that fits easily into the grooves 34 to achieve secure engagement of the tool 10 and the PTO driveline shaft 30. As the PTO driveline shaft comes in different diameters, the diameter of the semi-circular work head 16 can be lengthened or shortened accordingly to work with a particular size of the PTO shaft.

The features of the present invention which are believed to be novel are set forth below with particularity in the appended claims. However, modifications, variations, and changes to the exemplary embodiments described above will be apparent to those skilled in the art, and the tractor PTO driveline alignment tool described herein thus encompasses such modifications, variations, and changes and are not limited to the specific embodiments described herein.

1. An alignment tool for manually rotating a power take-off driveline shaft having a plurality of splines separated by a plurality of grooves, the tool comprising:
a semi-circular work head having first and second ends, wherein the first end includes a bent tip portion pointing inwardly toward a center of the semi-circular work head, and the second end is absent of a bent tip portion;
a handle having a first end attached tangentially to the second end of the semi-circular work head, wherein a longitudinal axis of the handle is disposed at an acute angle from the semi-circular work head; and
wherein the semi-circular work head is configured to fit around the power take-off driveline shaft with the bent tip portion engaging one of the plurality of grooves, and a force may be applied to the handle to manually rotate the power take-off driveline shaft.

2. The tool of claim 1, wherein the handle is a rod having a circular cross-section.

3. The tool of claim 1, wherein the handle is rectangular in shape.

4. The tool of claim 1, wherein the tip portion at the first end of the semi-circular work head is bent inwardly toward the center of the semi-circular work head.

5. The tool of claim 1, wherein the tip portion at the first end of the semi-circular work head comprises a blunt tip coupled to the first end of the semi-circular work head pointing inwardly toward the center of the semi-circular work head.

6. The tool of claim 1, wherein the tip portion at the first end of the semi-circular work head is at a right angle to the semi-circular work head.

7. The tool of claim 1, wherein the semi-circular work head is constructed of a material selected from the group consisting of ductile iron, aluminum, steel, and alloy metals.

8. The tool of claim 1, wherein the handle is constructed of a material selected from the group consisting of ductile iron, aluminum, steel, and alloy metals.

9. A power take-off driveline shaft alignment tool comprising:
a semi-circular work head having first and second ends, wherein the first end includes a tip portion pointing inwardly toward a center of the semi-circular work head; and
a handle having a first end attached to the second end of the semi-circular work head, wherein a longitudinal axis of the handle is disposed at an acute angle from the semi-circular work head.

10. The tool of claim 9, wherein the handle is a rod having a circular cross-section.

11. The tool of claim 9, wherein the handle is rectangular in shape.

12. The tool of claim 9, wherein the tip portion at the first end of the semi-circular work head is bent inwardly toward the center of the semi-circular work head.

13. The tool of claim 9, wherein the tip portion at the first end of the semi-circular work head comprises a blunt tip coupled to the first end of the semi-circular work head pointing inwardly toward the center of the semi-circular work head.

14. The tool of claim 9, wherein the tip portion at the first end of the semi-circular work head is at a right angle to the semi-circular work head.

15. The tool of claim 9, wherein the semi-circular work head is constructed of a material selected from the group consisting of ductile iron, aluminum, steel, and alloy metals.

16. The tool of claim 9, wherein the handle is constructed of a material selected from the group consisting of ductile iron, aluminum, steel, and alloy metals.

17-19. (canceled)

20. A tool for manually rotating a power take-off driveline shaft having a plurality of splines separated by a plurality of grooves, the tool comprising:
an asymmetric semi-circular work head having first and second ends, wherein the first end includes a bent work tip pointing inwardly toward a center of the semi-circular work head, the semi-circular work head disposed substantially in a plane;
an elongated handle having a first end tangentially attached to the semi-circular work head proximate to the second end thereof which is absent of a bent work tip, wherein a longitudinal axis of the elongated handle is disposed at an acute angle from the plane of the asymmetric semi-circular work head; and
wherein the semi-circular work head is configured to fit around the power take-off driveline shaft with the bent work tip engaging one of the plurality of grooves, and a force may be applied to the handle to manually rotate the power take-off driveline shaft.
